(19) United States
(12) Patent Application Publication
(10) Pub. No.: US 2015/0145892 A1
(43) Pub. Date: May 28, 2015

(54) DISPLAY APPARATUS FOR CONFIGURING A VIDEO WALL, DISPLAY SYSTEM, AND CONTROL METHOD THEREOF

(71) Applicant: SAMSUNG ELECTRONICS CO., LTD., Suwon-si (KR)

(72) Inventors: Sang-min HONG, Suwon-si (KR); Sang-keun LEE, Suwon-si (KR); Byoung-yoon NOH, Seoul (KR)

(73) Assignee: SAMSUNG ELECTRONICS CO., LTD., Suwon-si (KR)

(21) Appl. No.: 14/295,379

(22) Filed: Jun. 4, 2014

(30) Foreign Application Priority Data
Nov. 22, 2013 (KR) 10-2013-0143191

(51) Int. Cl. G06F 3/14; G06T 3/60

(52) U.S. Cl. CPC G06F 3/1446; G06T 3/60
USPC 345/649

(57) ABSTRACT

A display apparatus is disclosed. That is, a display apparatus from among a plurality of display apparatuses included in a video wall includes an image input image configured to receive an interlace image, a de-interlacer configured to de-interlace the input interlace image to generate an interpolation image, an image processor configured to separately rotate the interlace image and the interpolation image by a predetermined angle to generate a rotated progressive image, and an output configured to output on a screen an image of at least a portion of the rotated progressive image, which corresponds to the screen of the display apparatus.

### CROSS-REFERENCE TO RELATED APPLICATIONS

This application claims priority from Korean Patent Application No. 10-2013-0143191, filed on Nov. 22, 2013, in the Korean Intellectual Property Office, the disclosure of which is incorporated herein by reference, in its entirety.

### BACKGROUND

1. Technical Field

The exemplary embodiments relate to a display apparatus, a display system, and a control method thereof. More particularly, the exemplary embodiments relate to a display apparatus, a display system, and a control method thereof, for configuring a video wall.

2. Description of the Related Art

In general, a display apparatus is an apparatus for displaying an image on a screen. Various functions may be embodied using this display apparatus. One of these functions is a video wall function. The video wall function is a function of recognizing a plurality of displays as one display screen and enlarges and displays an image to 1×4, 2×2, 3×3, or 4×4 of its size. The video wall function may be used to enlarge and display one image on several display devices such as display device for a meeting room, presentation, a showroom, traffic, and stock, so as to allow a user to recognize the image displayed on the display devices at a glance.

In the related art, in order to rotate and display an image, a video wall system rotates an image input through a separate external device (e.g., an expensive CPU box), provides the rotated image to each display device, and displays a portion of the image, which corresponding to a location of each display device.

According such a method of the related art, in order to rotate and display an image, a video wall system needs to include a separate external device.

### SUMMARY

Exemplary embodiments overcome the above disadvantages and other disadvantages not described above. Also, the exemplary embodiments are not required to overcome the disadvantages described above, and an exemplary embodiment may not overcome any of the problems described above.

The exemplary embodiments provide a display apparatus, a display system, and a control method thereof, for rotating and displaying an image in each display apparatus included in a video wall system.

According to an aspect of the exemplary embodiments, a display apparatus from among a plurality of display apparatuses included in a video wall may include: an image input configured to receive an interlace image; a de-interlacer configured to de-interlace the input interlace image in order to generate an interpolation image; an image processor configured to separately rotate the interlace image and the interpolation image by a predetermined angle in order to generate a rotated progressive image; and an output configured to output on a screen including the plurality of display apparatuses, an image of at least a portion of the rotated progressive image, which corresponds to a screen of the display apparatus. The display apparatus may further include a storage, wherein the image processor may alternately write the interlace image and the interpolation image in the storage while separately rotating, by the predetermined angle in units of lines, to generate the rotated progressive image.

The interlace image may be one of an odd field image and an even field image, and the interpolation image may be the other field image.

The image processor may write the interlace image in a rightmost line and may alternately write the interpolation image in a next line in order to generate the rotated progressive image in response to the interlace image being an odd field image and the interpolation image is an even field image, in response to the interlace image and the interpolation image being rotated by 90 degrees, the image processor may be configured to write the interlace image in a leftmost line and may alternately write the interpolation image in a next line to generate the rotated progressive image in response to the interlace image being an odd field image and the interpolation image being an even field image, in response to the interlace image and the interpolation image being rotated by 270 degrees.

The image processor may be configured write the interpolation image in a rightmost line and may alternately write the interlace image in a next line to generate the rotated progressive image in response to the interlace image being an even field image and the interpolation image being an odd field image, in response to the interlace image and the interpolation image being rotated by 90 degrees; and the image processor may be configured to write the interpolation image in a leftmost line and may alternately write the interlace image in a next line to generate the rotated progressive image in response to the interlace image being an even field image and the interpolation image being an odd field image, in response to the interlace image and the interpolation image being rotated by 270 degrees.

The display apparatus may further include a storage, wherein the image processor may alternately write the interlace image and the interpolation image in the storage while separately rotating only images of portions of the interlace image and the interpolation image, which correspond to the screen, by the predetermined angle in units of lines to generate the rotated sub progressive image.

The display apparatus may further include a decoder configured to decode the input interlace image.

The display apparatus may further include a scaler configured to scale an image of the generated progressive image, which corresponds to a location of the screen, so as to be matched with a size of the screen.

According to another aspect of the exemplary embodiments, a method of controlling a display apparatus from among a plurality of display apparatuses included in a video wall includes receiving an interlace image, de-interlacing the input interlace image to generate an interpolation image, separately rotating the interlace image and the interpolation image by a predetermined angle to generate a rotated progressive image, and outputting an image of at least a portion of the rotated progressive image, which corresponds to a screen of the display apparatus, on a screen formed by the plurality of display apparatuses.

The generating of the rotated progressive image may include alternately writing the interlace image and the interpolation image in a memory while separately rotating the image by the predetermined angle in units of lines in order to generate the rotated progressive image.

The interlace image may be one of an odd field image and an even field image, and the interpolation image may be the other field image.

The generating of the rotated progressive image may include writing the interlace image in a rightmost line and alternately wiring the interpolation image in a next line to generate the rotated progressive image in response to the interlace image being an odd field image and the interpolation image being an even field image, in response to the interlace image and the interpolation image being rotated by 90 degrees, and writing the interlace image in a leftmost line and alternately writing the interpolation image in a next line to generate the rotated progressive image in response to the interlace image being an odd field image and the interpolation image being an even field image, in response to the interlace image and the interpolation image being rotated by 270 degrees.

The generating of the rotated progressive image may include writing the interpolation image in a rightmost line and alternately writing the interlace image in a next line to generate the rotated progressive image in response to the interlace image being an even field image and the interpolation image being an odd field image, in response to the interlace image and the interpolation image being rotated by 90 degrees, and writing the interpolation image in a leftmost line and alternately writing the interlace image in a next line to generate the rotated progressive image in response to the interlace image being an even field image and the interpolation image being an odd field image, in response to the interlace image and the interpolation image being rotated by 270 degrees.

The generating of the rotated progressive image may include alternately writing the interlace image and the interpolation image while separately rotating only images of portions of the interlace image and the interpolation image, which correspond to the screen, by the predetermined angle in units of lines in order to generate a rotated sub progressive image.

The method may further include decoding the input interlace image.

The method may further include scaling an image of the generated progressive image, which corresponds to a location of the screen, so as to be matched with a size of the screen.

An aspect of an exemplary embodiment may provide a video wall system comprising a plurality of display apparatuses which form a screen comprising the plurality of display apparatuses, the video wall system including: a first display apparatus configured to de-interlace an interlace image in order to generate an interpolation image, to separately rotate the interlace image and the interpolation image by a predetermined angle to generate a rotated progressive image, and to output a first image of the rotated progressive image, which corresponds to a screen on the display apparatus, on the screen of the plurality of display apparatuses; and a second display apparatus configured to de-interlace an interlace image to generate an interpolation image, to separately rotate the interlace image and the interpolation image by a predetermined angle in order to generate a rotated progressive image, and to output on a screen of the plurality of display apparatuses a second region of the rotated progressive image, corresponding to a screen.

The video wall system may further include a storage; wherein the first display apparatus is configured to alternately write the interlace image and the interpolation image in the storage while separately rotating the interlace image and the interpolation image, by the predetermined angle in units of lines, in order to generate the rotated progressive image.

The interlace image may be one of an odd field image and an even field image; and the interpolation image may be the other field image.

The first display apparatus is configured to alternately write the interlace image and the interpolation image in the storage while separately rotating only images of portions of the interlace image and the interpolation image, in order to generate a rotated sub progressive image.

As described above, according to an exemplary embodiment, since an image may be rotated and output in each display apparatus included in a video wall system, an external device for image rotation is not needed.

Additional and/or other aspects and advantages of the exemplary embodiments will be set forth in part in the description which follows and, in part, will be obvious from the description, or may be learned by practice of the exemplary embodiments.

### BRIEF DESCRIPTION OF THE DRAWINGS

The above and/or other aspects will be more apparent by describing certain exemplary embodiments with reference to the accompanying drawings, in which:

FIGS. 1A and 1B are diagrams for explanation of an operation of a video wall system for illustrative purposes;

FIGS. 2A and 2B are block diagrams which illustrate structures of display apparatuses according to exemplary embodiments;

FIGS. 3A and 3B are diagrams for brief explanation of an operation of a video wall system according to exemplary embodiments;

FIG. 4 is a schematic diagram for explanation of a method of generating a rotated progress image according to an exemplary embodiment;

FIGS. 5A and 5B are diagrams for detailed explanation of operations A and B illustrated in FIG. 4;

FIGS. 6A and 6B are diagrams for explanation of an operation C illustrated in detail in FIG. 4 according to an exemplary embodiment;

FIGS. 7A and 7B are diagrams for explanation of the operation C illustrated in detail in FIG. 4 according to another exemplary embodiment;

FIG. 8 is a diagram for explanation of a method of rotating an image according to an exemplary embodiment; and

FIG. 9 is a flowchart for explanation of a method of controlling a display apparatus according to an exemplary embodiment.

### DETAILED DESCRIPTION OF THE EXEMPLARY EMBODIMENTS

Certain exemplary embodiments will now be described in greater detail with reference to the accompanying drawings.

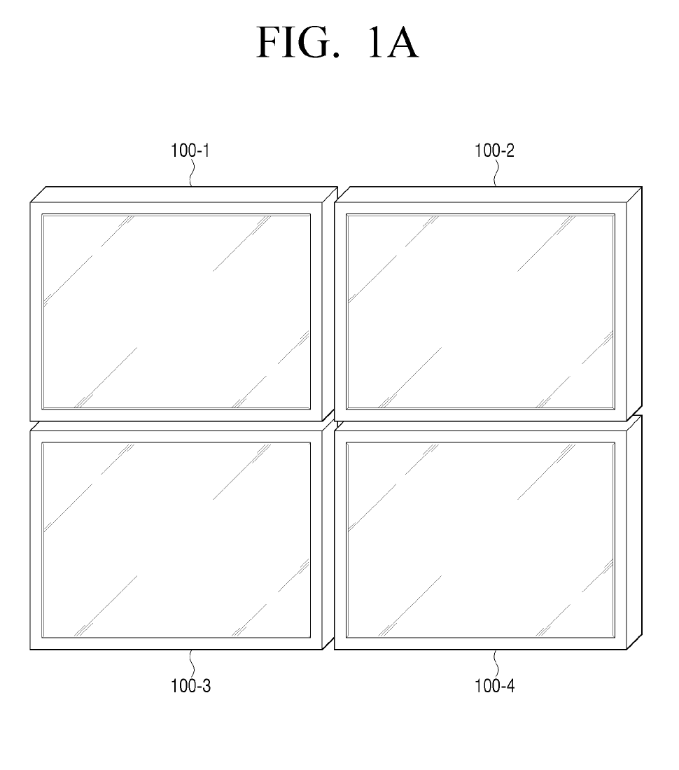

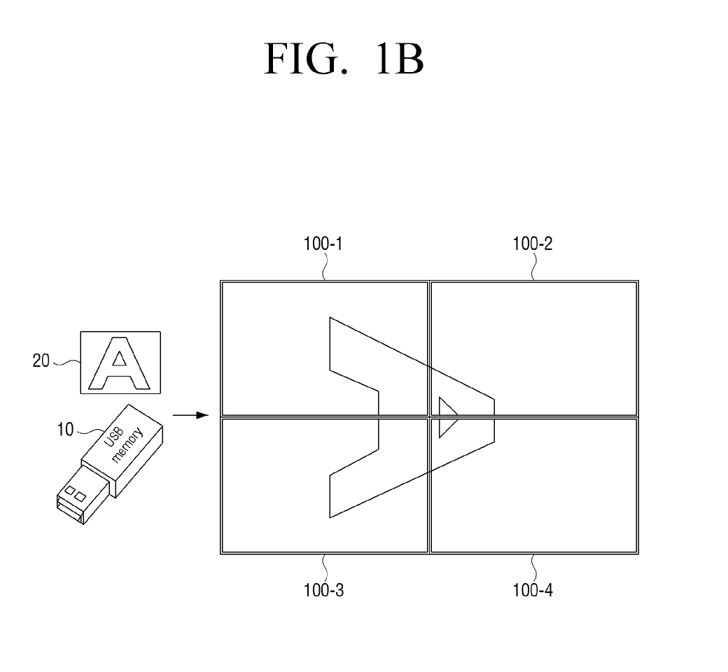

FIGS. 1A and 1B are diagrams for explanation of an operation of a video wall system, for illustrative purposes.

As illustrated in FIG. 1A, in general, the video wall system (or a multi-monitor system) includes a plurality of display apparatuses 100-1 to 100-4. For example, the plural display apparatuses 100-1 to 100-4 are arranged in the form of 2×2. That is, two display apparatus are arranged in a horizontal direction and two display apparatus are arranged in a vertical direction. This is purely exemplary for convenience of description and the number and arrangement type of all display apparatuses included in the video wall system may be change in various ways. The video wall system may be embodied as a large-sized large format display (LFD), a digital information display (DID), etc.

One of the display apparatuses 100-1 to 100-4 included in the video wall system may operate as a main display apparatus to control an operation of each sub-display apparatus, or alternatively a separate control device may be employed to control an operation of each of the display apparatuses 100-1 to 100-4.

Hereinafter, for convenience of description, a case in which one of the display apparatuses 100-1 to 100-4 operates as a main display apparatus will be described.

In FIG. 1A, assuming that an upper-left display apparatus 100-1 as a main display apparatus 100-1, upper-right, lower-left, and lower-right apparatus may be sub-display apparatuses 100-2, 100-3, and 100-4. The main display apparatus 100-1 may control an operation of each sub-display apparatus. In this case, the main display apparatus 100-1 and each of the sub-display apparatuses 100-2, 100-3, and 100-4 may perform a video wall function. Here, the video wall function has a function of recognizing a plurality of displays as one display screen, divides an image, and enlarges and displays the image on a plurality of display apparatuses.

In particular, the video wall system according to an exemplary embodiment may rotate and display an image 20 input from an input source 10, as necessary, as illustrated in FIG. 1B. For example, as illustrated in FIG. 1B, the input image 20 may be rotated by 90 degrees and may be enlarged and displayed on the plural display apparatuses 100-1 to 100-4.

In particular, a first display apparatus of a plurality of display apparatuses may de-interlace an input interlace image to generate an interpolation image, may separately rotate the interlace image and the interpolation image by a predetermined angle to generate a rotated progressive image, and, may then output on a screen an image of a first region of the rotated progressive image, which corresponds to the screen of the first display apparatus.

In addition, a second display apparatus of a plurality of display apparatuses may de-interlace an input interlace image to generate an interpolation image, may separately rotate the interlace image and the interpolation image by a predetermined angle to generate a rotated progressive image, and may then output on a screen an image of a second region of the rotated progressive image, which corresponds to the screen of the second display apparatus.

Hereinafter, a method of rotating and displaying an image input by each display apparatus included in a video wall system according to an exemplary embodiment will be described in more detail with reference to the accompanying drawings.

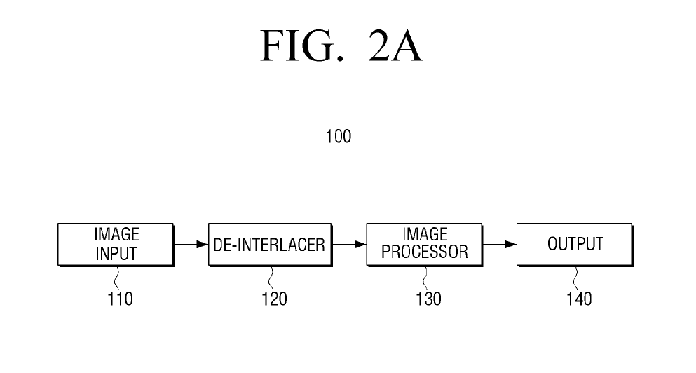

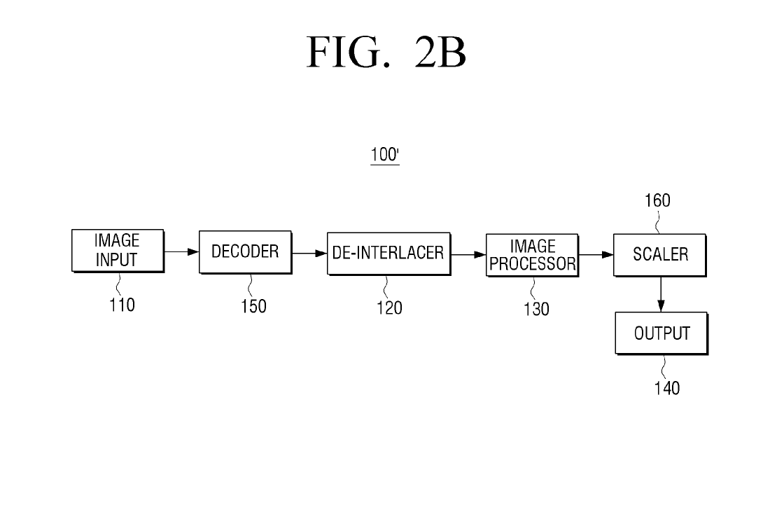

FIGS. 2A and 2B are block diagrams which illustrate structures of display apparatuses 100 and 100′ according to various exemplary embodiments.

Referring to FIG. 2A, the display apparatus 100 according to an embodiment of the present invention includes an image input 110, a de-interlacer 120, an image processor 130, and an output 140. Hereinafter, although the display apparatus 100 may be embodied as the main display apparatus 100-1 among the plural display apparatuses 100-1 to 100-4 included in the video wall system illustrated in FIG. 1, the sub-display apparatuses 100-2 to 100-4 may also perform a similar function.

The image input 110 may receive an image from various input sources. For example, the image input unit 110 may receive image data from an external device (e.g., a DVD, a BD player, a USB, etc.), may receive broadcast data from an external broadcast station, and receive image data stored in a storage (not shown).

In particular, the image input 110 may receive an interlace image, that is, an image with an interlace format. The interlace image is an image using an interlace method and the interlace method is a scan method for dividing one image frame into two frame fields and sequentially and alternatingly displaying the two frame fields on a screen. Thus, the interlace image may include only some fields of one image frame. For example, the interlace image may be an odd field image including only image data of one image frame, which corresponds to an odd line.

The de-interlacer 120 de-interlaces an input interlace image to generate an interpolation image. De-interlacing refers to an operation for generating an interpolation image in order to convert an interlace image into a progressive image. The progressive image is an image obtained by a method of simultaneously displaying all frames using one image frame as a frame unit, such as a method of projecting a film on a screen. Thus, in order to convert the interlace image into a progressive image, an interpolation image, that is, an image for interpolating one field image included in an interlace image is needed. In this regard, an operation for generating the interpolation image is referred to as de-interlacing.

The interpolation image may correspond to various types of images. For example, in response to the interlace image being an odd field image, the interpolation image may be an even field image. In response to the interlace image being a top field image, the interpolation image may be a bottom field image. In response to the interlace image being an upper field image, the interpolation image may be a lower field image. However, hereinafter, for convenience of description, an exemplary embodiment will be described in terms of a case in which the interlace image is an odd field image or an even field image.

The de-interlacer 120 may generate an even field image as an interpolation image in response the interlace image being an odd field image.

For example, in response to a currently input field being an nₜₕ odd field, the de-interlacer 120 may generate an interpolation image of an even line of an nₜₕ field with reference to images of an (n−1)ₜₕ even field as a previous field and an (n+1)ₜₕ even field as a next field.

In particular, the de-interlacer 120 includes a field memory (not shown) for storing an input interlace image, a motion detector (not shown) for determining motion of a pixel containing an object, etc. between fields, a spatial interpolator (not shown) for spatially performing interpolation as an interpolator for interpolation of each field, a temporal interpolator (not shown), and an adaptive mixer for appropriately distributing and performing spatial interpolation or temporal interpolation, according to the determined motion.

In response to the interlace image being input to the de-interlacer 120, a first field memory (not shown) stores the previous (n−1)ₜₕ image field. In addition, a second field memory (not shown) stores a current nₜₕ image field and performs an interpolation operation on the current nₜₕ image field. In order to perform temporal interpolation, a determination needs to be made that there is no motion of a line region to be interpolated. Thus, after waiting for a next image field to be input, the de-interlacer 120 compares the (n+1)ₜₕ image field with the (n−1)ₜₕ image field stored in the first field memory upon receiving the (n+1)ₜₕ image field. As a comparison result, in response to a determination that there is no motion from a slight difference between the previous (n−1)ₜₕ image field and the (n+1)ₜₕ image field, the de-interlacer 120 may receive the previous (n−1)ₜₕ image field and the next (n+1)ₜₕ image field from the temporal interpolator (not shown) and perform interpolation to generate an interpolation image with reference to a data value of a line to be interpolated.

On the other hand, in response to there being no motion, this means that a data value difference between the previous (n−1)ₜ, image field and the next (n+1)ₜₕ image field is large. In this case, different data may be reflected to a location to be interpolated during temporal interpolation to reduce a correlation with upper and lower lines of the current nₜₕ image field. Thus, the spatial interpolator (not shown) may perform inter-field interpolation such as inclination correlation interpolation, etc. using the current nₜₕ image field to generate the interpolation image.

However, the aforementioned method of generating an interpolation image is purely exemplary. Various methods of generating an interpolation image may be applied.

The image processor 130 separately rotates the interlace image and the interpolation image by a predetermined angle to generate a rotated progressive image. The predetermined angle may be, but is not limited to, 90 degrees or 270 degrees.

In particular, the image processor 130 may alternately write the interlace image and the interpolation image while rotating the interlace image and interpolation image in units of lines in order to generate the rotated progressive image.

For example, in response to the interlace image being an odd field image and the interpolation image being an even field image, in response to the interlace image and interpolation image being rotated by 90 degrees, the image processor 130 may write the interlace image in a rightmost line and alternately write the interpolation image in a next line to generate the rotated progressive image.

In addition, upon rotating the interlace image and interpolation image by 270 degrees, the image processor 130 may write the interlace image in a leftmost line and alternately write the interpolation image in a next line to generate the rotated progressive image.

As another example, in response the interlace image being an even field image and the interpolation image being an odd field image, in response to the interlace image and interpolation image being rotated by 90 degrees, the image processor 130 may write the interpolation image in a rightmost line and alternately write the interlace image in a next line to generate the rotated progressive image. In addition, upon rotating the interlace image and interpolation image by 270 degrees, the image processor 130 may write the interpolation image in a leftmost line and alternately write the interlace image in a next line to generate the rotated progressive image.

As necessary, the image processor 130 may separately rotate only images of regions of the interlace image and the interpolation image, which correspond to a screen of the display apparatus 100, to generate a rotated sub-progressive image. That is, the image processor 130 may process only a sub-image to be displayed on the screen of the corresponding display apparatus 100, from among all target screens of the video wall system to generate the sub-progressive image.

The aforementioned operation of the image processor 130 will be described in more detail with reference to the accompanying drawings.

The output 140 outputs on a screen the rotated progressive image generated by the image processor 130.

In particular, the output 140 may output an image of at least a portion of the rotated progressive image generated by the image processor 130, which corresponds to the screen. The output 140 may be embodied as, but is not limited to, a liquid crystal display panel (LCD), an organic light emitting diode (OLED), etc. In addition, as necessary, the output 140 may be embodied as a flexible display, a transparent display, etc.

Referring to FIG. 2B, the display apparatus 100 according to another exemplary embodiment includes the image input 110, the de-interlacer 120, the image processor 130, the output 140, a decoder 150, and a scaler 160. Detailed description of repeated components of FIG. 2A among components illustrated in FIG. 2B will be omitted herein.

The decoder 150 may decode an input image.

In particular, the decoder 150 may decode the input image and provide the decoded image to other display apparatuses included in the video wall system. That is, a main display apparatus among a plurality of display apparatuses included in the video wall system may decode an image and provide the decoded image to sub-display apparatuses. In this case, the sub-display apparatuses may receive and de-interlace the decoded interlace image to generate the interpolation image.

In particular, the decoder 150 may provide decoded audio/video data and sink information to each sub-display apparatus. In this case, each sub display apparatus may process and output the input decoded audio/video data based on the sink information input from the main display apparatus.

The scaler 160 scales the image processed by the image processor 130 and provides the scaled image to the output 140.

According to an exemplary embodiment, the scaler 160 may scale the progressive image generated by the image processor 130 so as to match a portion of the progressive image, which corresponds to a location of a screen of the output 140, with the size of the screen. In this case, the scaler 160 may determine a corresponding image based on information related to a region in which the screen of the display apparatus 100 of the video wall system is positioned, and enlarge the determined image so as to be matched with the size of the screen.

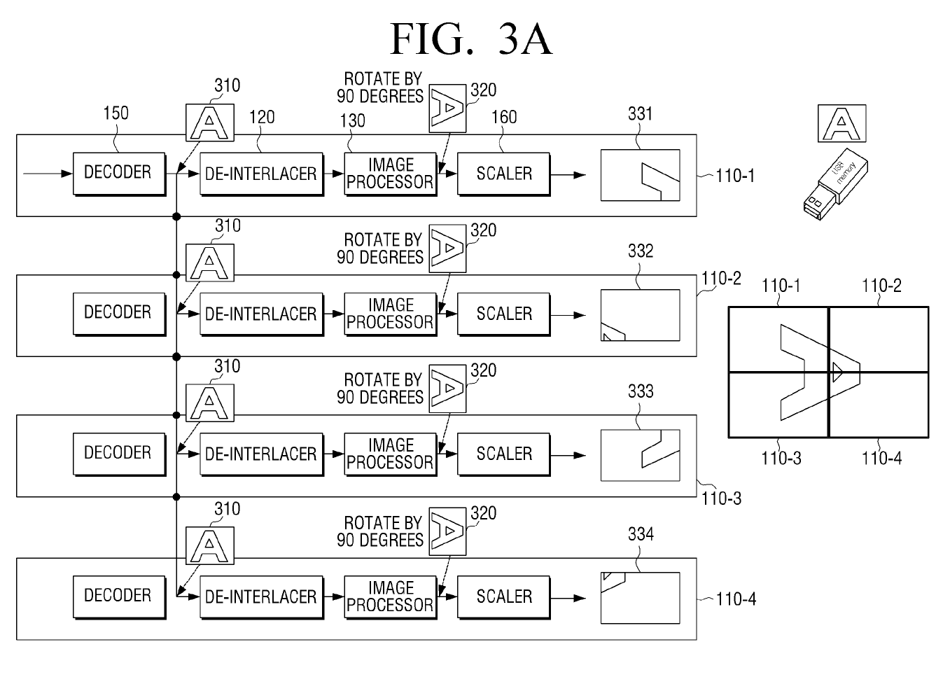

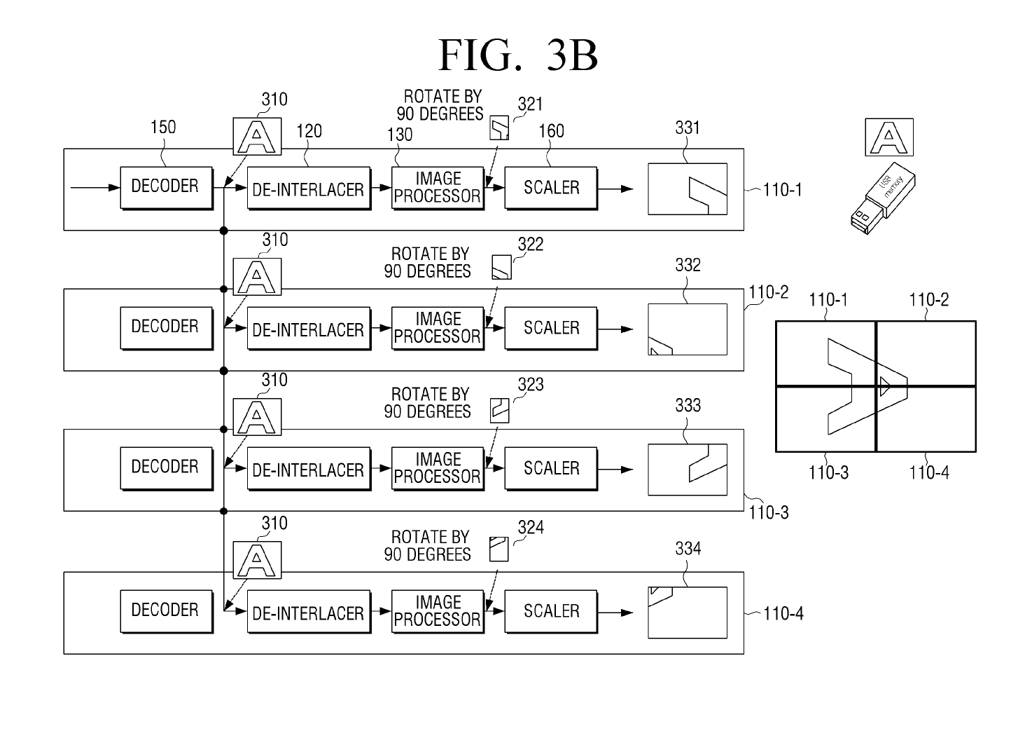

FIGS. 3A and 3B are diagrams which provide a brief explanation of an operation of a video wall system according to various exemplary embodiments.

As illustrated in FIGS. 3A and 3B, in response the video wall system including four display apparatuses (or display panels) 100-1 to 100-4, an interlace image input to the main display apparatus 100-1 may be decoded by the decoder 150 included in the main display apparatus 100-1 and may be provided to each of the sub-display apparatuses 100-2 to 100-4.

As illustrated in FIG. 3A, according to an exemplary embodiment, the main display apparatus 100-1 and each of the sub-display apparatuses 100-2 to 100-4 may receive a decoded interlace image 310 to generate a progress image 320 rotated via the de-interlacer 120 and the image processor 130. The scaler 160 may scale an image corresponding to each screen in order to generate the scaled sub images 331 to 334. In this case, each of the display apparatuses 100-1 to 100-4 outputs each sub image scaled according to each screen and provides a rotated image to the video wall system.

As illustrated in FIG. 3B, according to another exemplary embodiment the main display apparatus 100-1 and each of the sub-display apparatuses 100-2 to 100-4 may receive a decoded interlace image 310 to generate a sub progress image 320 rotated via the de-interlacer 120 and the image processor 130. That is, unlike in the exemplary embodiment illustrated in FIG. 3A, the image processor 130 may generate a sub progress image which corresponds to a screen of each of the display apparatuses 100-1 to 100-4 and provide the sub progress image to the scaler 160.

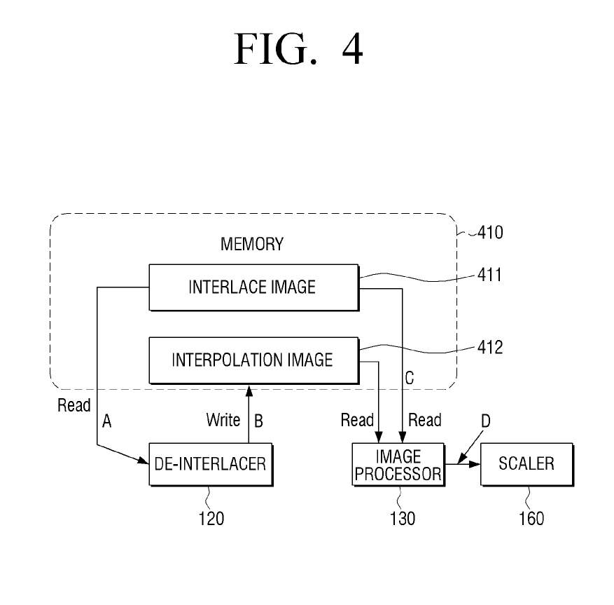

FIG. 4 is a schematic diagram for explanation of a method of generating a rotated progress image according to an exemplary embodiment.

As illustrated in FIG. 4, the de-interlacer 120 may read (A) and de-interlace an interlace image 411 from a memory 410 to write (B) an interpolation image 412 in the memory 410.

Then, the image processor 130 may read (C) the interlace image 411 and the interpolation image 412 from the memory 410 to generate a rotated progress image and provide (D) the rotated progress image to the scaler 160.

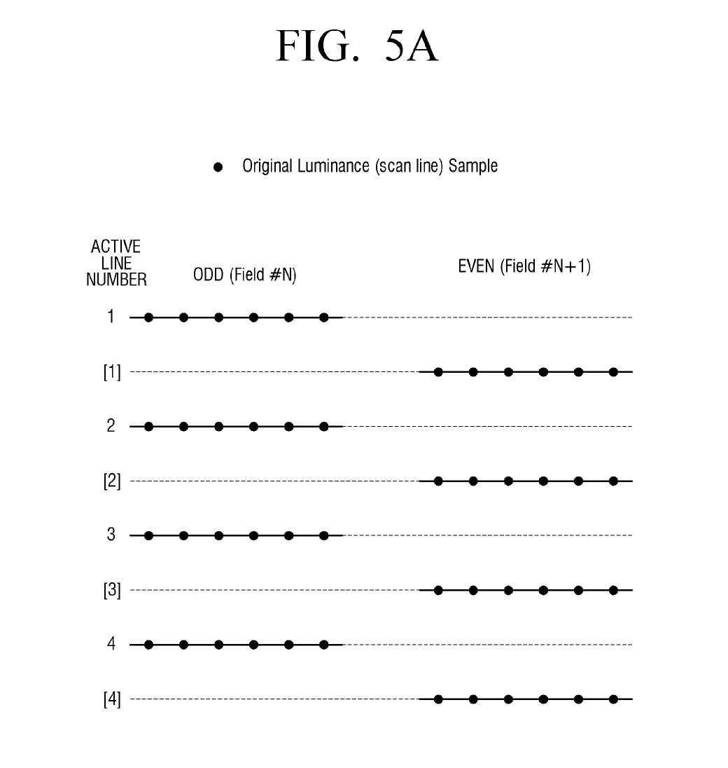

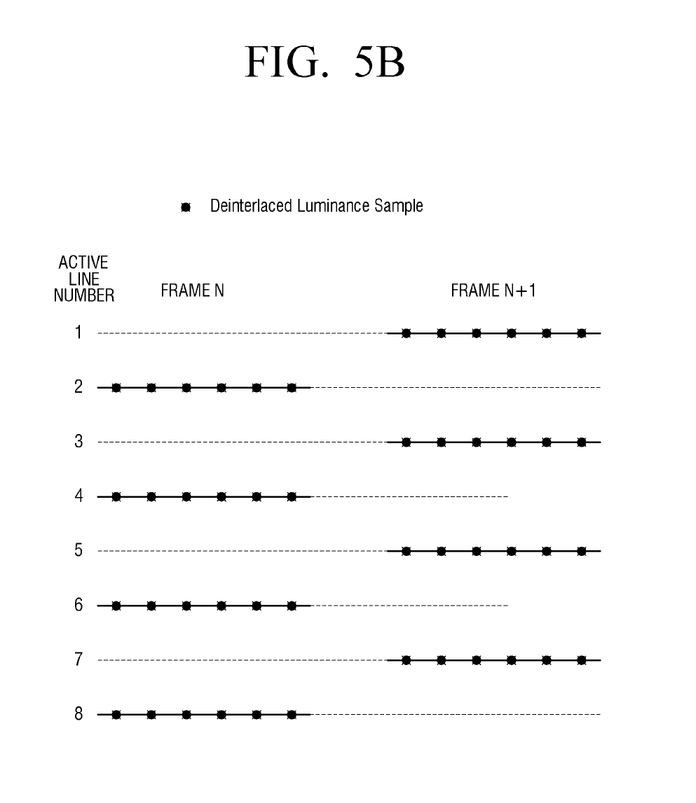

FIGS. 5A and 5B are diagrams which provide a detailed explanation of operations A and B illustrated in FIG. 4.

FIG. 5A illustrates a format of the interlace image 411 read via the operation A. The interlace image 411 may be an odd field image illustrated in a left portion of FIG. 5A and may be an even field image illustrated in a right portion of FIG. 5A.

That is, as illustrated in the left portion of FIG. 5A, the odd field image may contain image data in an odd line, and as illustrated in the right portion of FIG. 5A, the even field image may contain image data in an even line.

FIG. 5B illustrates a format of the interpolation image 412 written in the memory 410, which is generated via the de-interlacer 120. In response to an interlace image being an odd field image (a left portion of FIG. 5A), the interpolation image may be an even field image, as illustrated in a left portion of FIG. 5B. In response to an interlace image being an even field image (a right portion of FIG. 5A), the interpolation image may be an odd field image, as illustrated in a right portion of FIG. 5B.

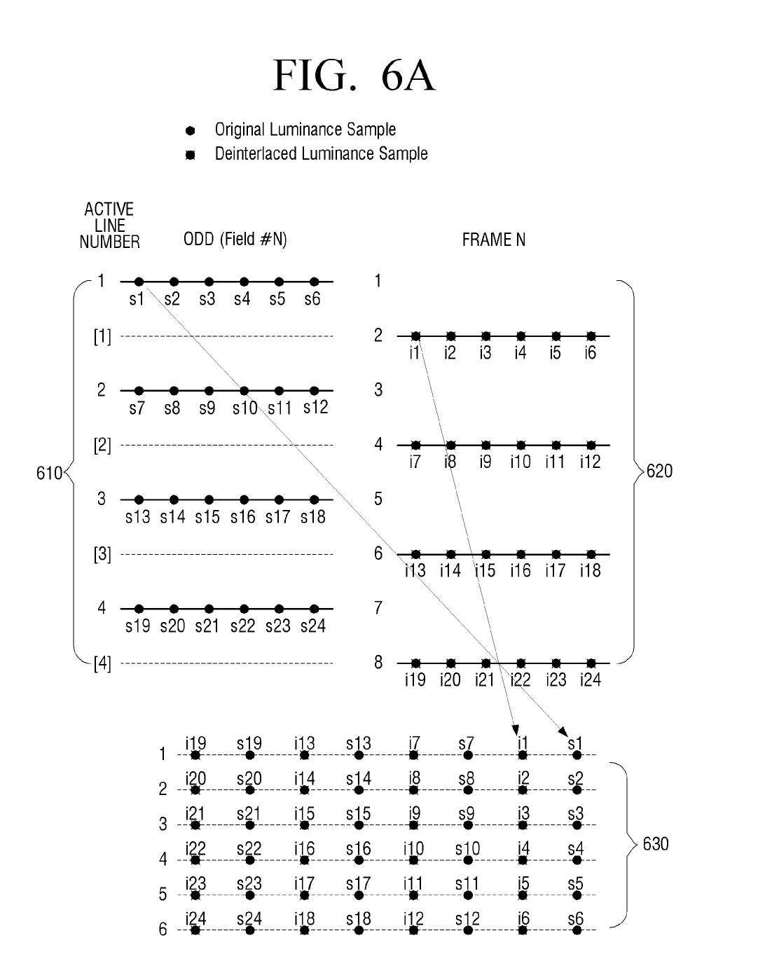

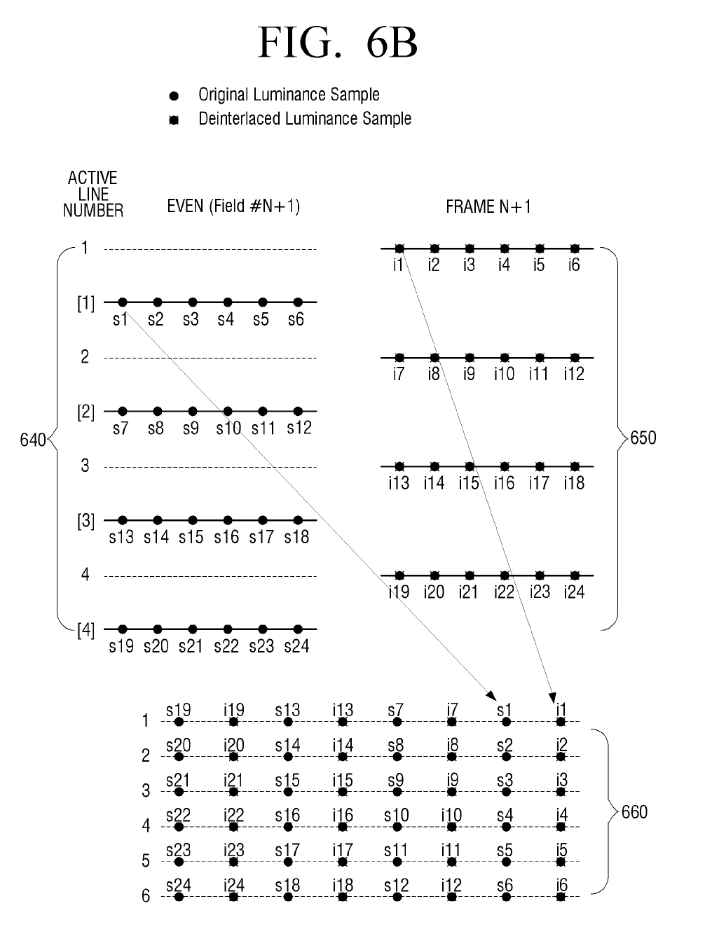

FIGS. 6A and 6B are diagrams for a detailed explanation of an operation C illustrated in FIG. 4, according to an exemplary embodiment.

FIG. 6A illustrates an operation for generating a progress image 630 rotated by 90 degrees in response to an interlace image being an odd field image 610 and an interpolation image is an even field image 620.

As illustrated in FIG. 6A, image data which corresponds to an odd line of the interlace image 610 and image data which corresponds to an even line of the interpolation image 620 may be rotated by 90 degrees and may be alternately written to generate the progress image 630. For example, as illustrated in FIG. 6A, image data s1, s2, s3, s4, s5, and s6 positioned in a first line of an interlace image, that is, a first row may be read and may be written in a rightmost line, and image data i1, i2, i3, i4, i5, and i6 positioned in a first line of the interpolation image, that is, a second row may be read and may be written in a next line. A lower diagram 630 of FIG. 6A illustrates a frame format rotated by 90 degrees, which is finally generated.

FIG. 6B illustrates an operation for generating a progress image 660 rotated by 90 degrees when an interlace image is an even field image 640 and an interpolation image is an odd field image 650.

As illustrated in FIG. 6B, image data which corresponds to an odd line of an interpolation image 650 and image data which corresponds to an even line of an interlace image 640 may be rotated by 90 degrees and may be alternately written to generate the progress image 660. For example, as illustrated in FIG. 6B, image data i1, i2, i3, i4, i5, and i6 positioned in a first line of the interpolation image 650 may be written in a rightmost line and the image data s1, s2, s3, s4, s5, and s6 positioned in a first line of an interlace image, that is, a first row may be read and may be written in a next line. A lower diagram 660 of FIG. 6B illustrates a frame format rotated by 90 degrees, which is finally generated.

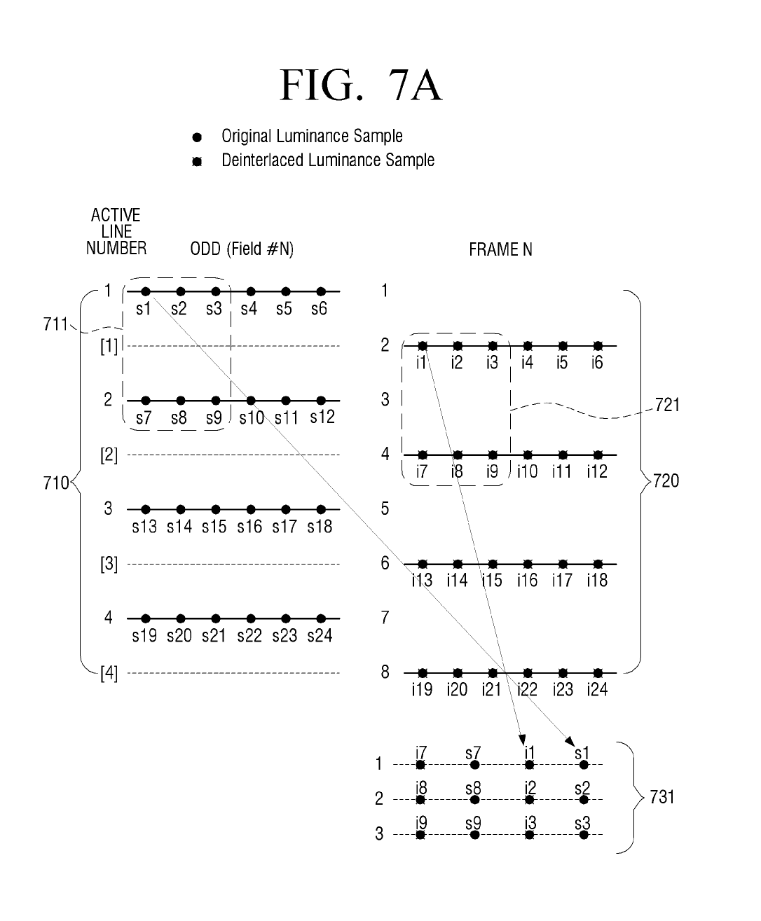

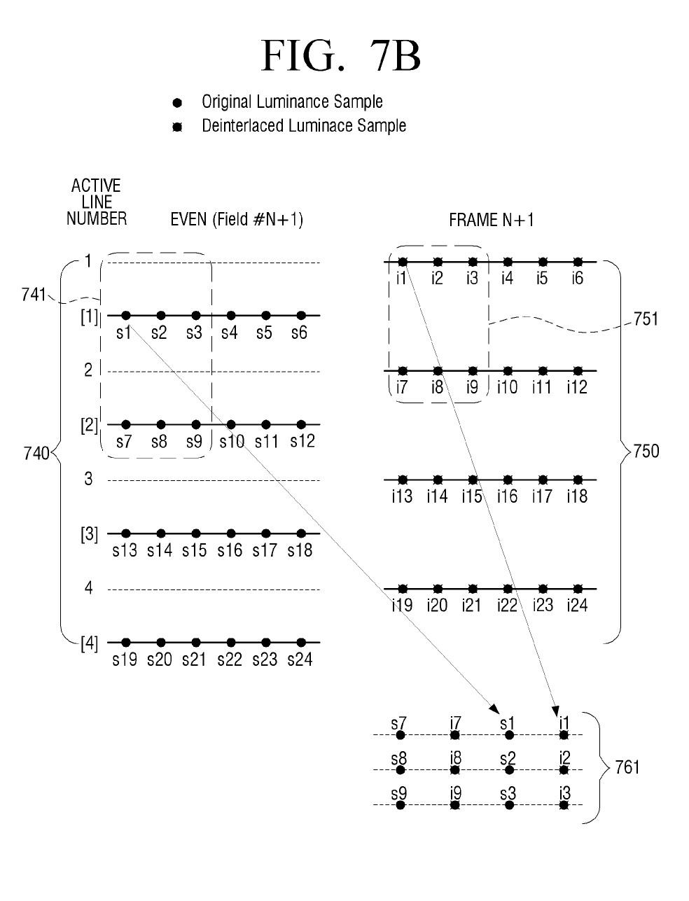

FIGS. 7A and 7B are diagrams for a detailed explanation of the operation C illustrated FIG. 4, according to another exemplary embodiment.

Unlike in the exemplary embodiment illustrated in FIGS. 6A and 6B, according to another exemplary embodiment, as illustrated in FIGS. 7A and 7B, only images of portions of the interlace image and the interpolation image, which correspond to a screen of a corresponding display apparatus included in a video wall system, may be rotated to generate a progress image.

That is, as illustrated in FIGS. 7A and 7B, only image data which corresponds to regions 711 and 741 of interlace images 710 and 740, which correspond to a screen of a corresponding display apparatus, and which corresponds to regions 721 and 751 of the interlace images 710 and 740, which correspond to the screen of the corresponding display apparatus may each be rotated by 90 degrees and may each be alternately written to generate sub progress images 731 and 761 which correspond to the corresponding screen.

FIG. 7A illustrates an operation for generating a sub progress image rotated by 90 degrees in response to an interlace image being an odd field image 710 and an interpolation image being an even field image 720.

For example, as illustrated in FIG. 7A, image data s1, s2, and s3 positioned in a first line of a region 711 of the interlace image 710, that is, a first row, which corresponds to a screen of the corresponding display apparatus, may be written in a rightmost line, and image data i1, i2, and i3 positioned in a first line of a region 721 of the interpolation image 720, that is, a second row, which corresponds to the screen of the corresponding display apparatus, may be read and may be written in a next line. A lower diagram of FIG. 7A illustrates a format of a sub image 731 rotated by 90 degrees, which is finally generated.

FIG. 7B illustrates an operation for generating a sub progress image rotated by 90 degrees in response to an interlace image is an even field image 740 and an interpolation image is an odd field image 750.

For example, as illustrated in FIG. 7B, the image data i1, i2, and i3 positioned in a first line of a region 741 of the interpolation image 740, that is, a first row, which corresponds to a screen of the corresponding display apparatus, may be written in a rightmost line, and the image data s1, s2, and s3 positioned in a first line of a region 751, that is, a second row, which corresponds to the screen of the corresponding display apparatus, may be read and may be written in a next line. A lower diagram of FIG. 7B illustrates a format of a sub image 761 rotated by 90 degrees, which is finally generated.

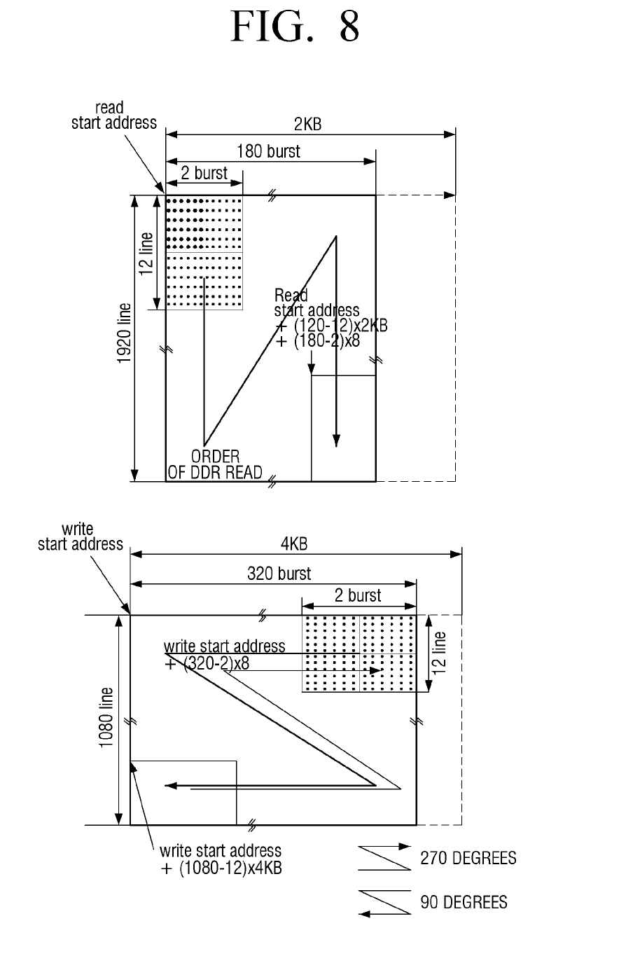

FIG. 8 is a diagram for explanation of an image rotate method according to an exemplary embodiment.

As illustrated in FIG. 8, an image may be divided into blocks, may be sequentially read, and then may be sequentially written to generate a rotated image.

In particular, as illustrated in an upper portion of FIG. 8, in response to an original image being read, blocks may be sequentially read in a lower direction and a right direction from an uppermost block of a leftmost line.

In addition, as illustrated in a lower portion of FIG. 8, when an image is rotated and written, in response to the image being rotated by 90 degrees, blocks may be sequentially written in a lower direction and a left direction from an uppermost block of a rightmost line, and in response to the image being rotated by 270 degrees, blocks may be sequentially written in an upper direction and a right direction from a lowermost block of a leftmost column to generate a rotated image.

In the aforementioned exemplary embodiments, each pixel is divided in units of blocks and the blocks are read and written, which is purely exemplary. According to another exemplary embodiment, each pixel may be read and written in units of sub pixels or units of pixels.

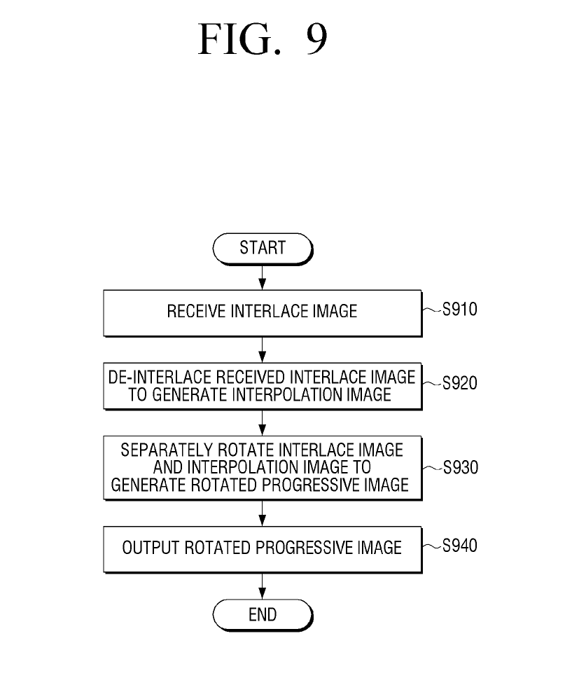

FIG. 9 is a flowchart for explanation of a method of controlling a display apparatus according to an exemplary embodiment.

As illustrated in FIG. 9, according to the method of controlling one of a plurality of display apparatuses included in a video wall, in response to an interlace image being input (S910), the input interlace image is de-interlaced to generate an interpolation image (S920).

Then, the interlace image and the interpolation image are separately rotated by a predetermined angle to generate a rotated progressive image (S930).

An image of at least a portion of the rotated progressive image, which corresponds to a screen of the display apparatus, is the output on the screen (S940).

In addition, in operation S930 for generating the rotated progressive image, the interlace image and the interpolation image may be alternately written in a memory while being separately rotated by a predetermined angle in units of lines in order to generate a rotated progressive image.

The interlace image may be one of an odd field image and an even field image, and the interpolation image may be the other field image.

In addition, in operation S930 for generating the rotated progressive image, in response to the interlace image being an odd field image and the interpolation image being an even field image, in response to the interlace image and the interpolation image being rotated by 90 degrees, the interlace image may be written in a rightmost line and the interpolation image may be alternately written in a next line to generate a rotated progressive image. In addition, in response to the interlace image and the interpolation image being rotated by 270 degrees, the interlace image may be written in a leftmost line and the interpolation image may be alternately written in a next line to generate a rotated progressive image.

In operation S930 for generating the rotated progressive image, in response to the interlace image being an even field image and the interpolation image being an odd field image, in response to the interlace image and the interpolation image being rotated by 90 degrees, the interpolation image may be written in a rightmost line and the interlace image may be alternately written in a next line to generate the rotated progressive image. In addition, in response to the interlace image and the interpolation image being rotated by 270 degrees, the interpolation image may be written in a leftmost line and the interlace image may be alternately written in a next line to generate a rotated progressive image.

In operation S930 for generating the rotated progressive image, only images of portions of the interlace image and the interpolation image, which correspond to a screen of the display apparatus, may be alternately written in a storage while being separately rotated by a predetermined angle in units of lines in order to generate the rotated sub progressive image.

The method may further include decoding the input interlace image.

In addition, the method may further include scaling an image of the generated progressive rotated image, which corresponds to a location of the screen, so as to be matched with the size of the screen.

The aforementioned exemplary embodiment has been described in terms of a case in which an input image is an interlace image. However, the feature may also be applied to a case in which the input image is a progress image. That is, in response to the input image being a progress image, each display apparatus included in a video wall system may rotate and display the input image.

As described above, according to the exemplary embodiments, since an image may be rotated and output in each display apparatus included in a video wall system, an external device for image rotation is not needed.

In particular, a control method of a display apparatus according to the aforementioned various embodiments may be embodied as a computer readable program code executable on a computer and provided to each server or device so as to be executed by a processor while being stored in various non-transitory readable storage media.

For example, a non-transitory computer readable storage medium for storing a program for execution of a method including de-interlacing an input interlace image to generate an interpolation image, separately rotating the interlace image and the interpolation image by a predetermined angle, and generating a rotated progressive image, may be provided to the display apparatus.

The non-transitory computer readable medium is a medium that semi-permanently stores data and from which data is readable by a device, but not a medium that stores data for a short time, such as register, a cache memory, and the like. In particular, the aforementioned various applications or programs may be stored in the non-transitory computer readable storage medium, for example, a compact disc (CD), a digital versatile disc (DVD), a hard disc, a Blue-ray Disc™, a universal serial bus (USB), a memory card, a read only memory (ROM), and the like, and may be provided.

The foregoing exemplary embodiments and advantages are merely exemplary and are not to be construed as limiting. The present teachings can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus among a plurality of display apparatuses included in a video wall, the display apparatus comprising:
an image input configured to receive an interlace image;
a de-interlacer configured to de-interlace the input interlace image in order to generate an interpolation image;
an image processor configured to separately rotate the interlace image and the interpolation image by a predetermined angle in order to generate a rotated progressive image; and
an output configured to output on a screen comprised of the plurality of display apparatuses, an image of at least a portion of the rotated progressive image, which corresponds to a screen of the display apparatus.

2. The display apparatus as claimed in claim 1, further comprising a storage
wherein the image processor is configured to alternately write the interlace image and the interpolation image in the storage while separately rotating, by the predetermined angle in units of lines, in order to generate the rotated progressive image.

3. The display apparatus as claimed in claim 2, wherein:
the interlace image is one of an odd field image and an even field image; and the interpolation image is the other field image.

4. The display apparatus as claimed in claim 3, wherein:
the image processor is configured to write the interlace image in a rightmost line and to alternately write the interpolation image in a next line to generate the rotated progressive image in response to the interlace image being an odd field image and the interpolation image is an even field image, in response the interlace image and the interpolation image are rotated by 90 degrees; and
the image processor is configured to write the interlace image in a leftmost line and to alternately write the interpolation image in a next line to generate the rotated progressive image in response to the interlace image being an odd field image and the interpolation image is an even field image, in response to the interlace image and the interpolation image being rotated by 270 degrees.

5. The display apparatus as claimed in claim 3, wherein:
the image processor is configured to write the interpolation image in a rightmost line and to alternately write the interlace image in a next line to generate the rotated progressive image in response to the interlace image being an even field image and the interpolation image being an odd field image, in response to the interlace image and the interpolation image being rotated by 90 degrees; and
the image processor is configured to write the interpolation image in a leftmost line and to alternately write the interlace image in a next line to generate the rotated progressive image in response to the interlace image being an even field image and the interpolation image being an odd field image, in response to the interlace image and the interpolation image being rotated by 270 degrees.

6. The display apparatus as claimed in claim 1, further comprising a storage,
wherein the image processor is configured to alternately write the interlace image and the interpolation image in the storage while separately rotating only images of portions of the interlace image and the interpolation image, which correspond to the screen of the display apparatus, by the predetermined angle in units of lines, in order to generate a rotated sub progressive image.

7. The display apparatus as claimed in claim 1, further comprising a decoder configured to decode the input interlace image.

8. The display apparatus as claimed in claim 1, further comprising a scaler configured to scale an image of the generated progressive image, which corresponds to a location of the screen of the display apparatus, so as to be matched with a size of the screen comprised of the display apparatuses.

9. A method of controlling a display apparatus among a plurality of display apparatuses included in a video wall, the method comprising:
receiving an interlace image;
de-interlacing the input interlace image to generate an interpolation image;
separately rotating the interlace image and the interpolation image by a predetermined angle to generate a rotated progressive image; and
outputting an image of at least a portion of the rotated progressive image, which corresponds to a screen of the display apparatus, on a screen formed by the plurality of display apparatuses.

10. The method as claimed in claim 9, wherein the generating of the rotated progressive image comprises alternately writing the interlace image and the interpolation image in a memory while separately rotating, by the predetermined angle in units of lines, in order to generate the rotated progressive image.

11. The method as claimed in claim 10, wherein:
the interlace image is one of an odd field image and an even field image; and
the interpolation image is the other field image.

12. The method as claimed in claim 11, wherein the generating of the rotated progressive image comprises:
writing the interlace image in a rightmost line and alternately wiring the interpolation image in a next line to generate the rotated progressive image in response to the interlace image being an odd field image and the interpolation image being an even field image, in response to the interlace image and the interpolation image being rotated by 90 degrees; and
writing the interlace image in a leftmost line and alternately writing the interpolation image in a next line to generate the rotated progressive image in response to the interlace image being an odd field image and the interpolation image being an even field image, in response to the interlace image being and the interpolation image being rotated by 270 degrees.

13. The method as claimed in claim 11, wherein the generating of the rotated progressive image comprises:
writing the interpolation image in a rightmost line and alternately writing the interlace image in a next line to generate the rotated progressive image in response to the interlace image being an even field image and the interpolation image being an odd field image, in response to the interlace image and the interpolation image being rotated by 90 degrees; and
writing the interpolation image in a leftmost line and alternately writing the interlace image in a next line to generate the rotated progressive image in response to the interlace image being an even field image and the interpolation image being an odd field image, if the interlace image and the interpolation image are rotated by 270 degrees.

14. The method as claimed in claim 9, wherein the generating of the rotated progressive image comprises alternately writing the interlace image and the interpolation image while separately rotating only images of portions of the interlace image and the interpolation image, which correspond to the screen, by the predetermined angle in units of lines, in order to generate a rotated sub progressive image.

15. The method as claimed in claim 9, further comprising decoding the input interlace image.

16. The method as claimed in claim 9, further comprising scaling an image of the generated progressive image, which corresponds to a location of a screen comprising the plurality of display apparatuses, so as to be matched with a size of the screen.

17. A video wall system comprising a plurality of display apparatuses which form a screen comprising the plurality of display apparatuses, the video wall system comprising:
a first display apparatus configured to de-interlace an interlace image in order to generate an interpolation image, to separately rotate the interlace image and the interpolation image by a predetermined angle to generate a rotated progressive image, and to output a first image of the rotated progressive image, which corresponds to a screen on the display apparatus, on the screen of the plurality of display apparatuses; and
a second display apparatus configured to de-interlace an interlace image to generate an interpolation image, to separately rotate the interlace image and the interpolation image by a predetermined angle in order to generate a rotated progressive image, and to output on a screen of the plurality of display apparatuses a second region of the rotated progressive image.

18. The video wall system of claim 17, further comprising a storage;
wherein the first display apparatus is configured to alternately write the interlace image and the interpolation image in the storage while separately rotating the interlace image and the interpolation image, by the predetermined angle in units of lines, in order to generate the rotated progressive image.

19. The video wall system of claim 18, wherein the interlace image is one of an odd field image and an even field image; and the interpolation image is the other field image.

20. The video wall system of claim 18, wherein the first display apparatus is configured to alternately write the interlace image and the interpolation image in the storage while separately rotating only images of portions of the interlace image and the interpolation image, in order to generate a rotated sub progressive image.
